(19) United States
(12) Patent Application Publication
(10) Pub. No.: US 2012/0268330 A1
(43) Pub. Date: Oct. 25, 2012

(54) ANTENNA DEVICES AND PORTABLE ELECTRONIC DEVICES COMPRISING SUCH ANTENNA DEVICES

(76) Inventors: Stefan Irmscher, Taby (SE); Peter Lindberg, Uppsala (SE)

(21) Appl. No.: 13/541,966

(22) Filed: Jul. 5, 2012

Related U.S. Application Data
(63) Continuation of application No. PCT/EP2010/051289, filed on Feb. 3, 2010.

(51) Int. Cl. H01Q 7/00

(52) U.S. Cl. 343/702; 343/748

(57) ABSTRACT

An exemplary embodiment of an antenna device generally includes a loop element having a length providing loop resonance at a first wavelength, where a resonance frequency of this wavelength is used in a desired frequency band. A capacitance is provided between a first position on the element and ground, thereby dividing the element into a first and a second section. The second section has an inductance that depends on the length and forms a resonance circuit with the capacitance which causes the element to function as a monopole element at the resonance frequency of the resonance circuit. The first position and capacitance are configured for the resonance circuit resonance frequency to lie in the desired frequency band. The first position is configured such that the length of the first section provides a monopole resonance at a second wavelength having one resonance frequency at the resonance circuit resonance frequency.

### CROSS-REFERENCE TO RELATED APPLICATION

This application is a continuation of PCT International Patent Application No. PCT/EP2010/051289 filed Feb. 3, 2010, published as WO2011/095207. The entire disclosure of the above application is incorporated herein by reference.

### FIELD

The present disclosure relates generally to antenna devices for use in portable radio communication devices, such as mobile phones.

### BACKGROUND

This section provides background information related to the present disclosure which is not necessarily prior art.

Internal antennas have been used for some time in portable radio communication devices. There are a number of advantages connected with using internal antennas, of which can be mentioned that they are small and light, making them suitable for applications wherein size and weight are of importance, such as in mobile phones.

One type of frequently used antenna in this regard is the Planar Inverted F Antenna (PIFA), which essentially uses the whole device as a radiator. This antenna functions well and provides good multi-band functionality.

But there may be a problem when a portable radio communication device or terminal having this type of antenna is used by a person having hearing aid equipment. There might be interference in this hearing aid equipment caused by such an antenna. Therefore, there exists a so-called Hearing Aid Compatibility (HAC) requirement in some countries. This complicates the use of the PIFA antenna. In order to fulfill the requirement, research has been made into alternative antennas.

One antenna that is promising is the loop antenna. One reason for this is that the loop antenna, at some frequencies, does not use the whole terminal as a radiator. Therefore, it is possible to place the antenna far from the end of the terminal intended to face a hearing aid and thereby obtain interference reduction.

But there is a problem with this type of antenna and that is the bandwidth covered. Today's antennas for use in cellular communication, like Long Term Evolution (LTE), are to cover a number of wide frequency bands, where a first band is around 900 MHz and a second band is between 1710 and 2170 MHz. The loop antenna has problems in being able to cover the very wide second band. There is thus a need for providing a loop antenna that has a better wide band capacity, for instance when covering a first lower band of medium width together with a second higher band of higher width.

### SUMMARY

This section provides a general summary of the disclosure, and is not a comprehensive disclosure of its full scope or all of its features.

According to various aspects, exemplary embodiments are disclosed of antenna devices. In an exemplary embodiment, an antenna device generally includes a loop element having a length providing loop resonance at a first wavelength, where a resonance frequency of this wavelength is used in a desired frequency band. A capacitance is provided between a first position on the element and ground, thereby dividing the element into a first and a second section. The second section has an inductance that depends on the length and forms a resonance circuit with the capacitance which causes the element to function as a monopole element at the resonance frequency of the resonance circuit. The first position and capacitance are configured for the resonance circuit resonance frequency to lie in the desired frequency band. The first position is configured such that the length of the first section provides a monopole resonance at a second wavelength having one resonance frequency at the resonance circuit resonance frequency.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front view of an exemplifying portable radio communication device;

FIG. 2 is a sectional view of the portable electronic device shown in FIG. 1;

FIG. 3 schematically shows a general antenna device according to a first variation together with a ground plane and a radio communication circuit;

FIG. 4 schematically shows a first embodiment of the antenna device according to the first variation together with a ground plane and a radio communication circuit;

FIG. 5 shows a resonance circuit formed by the antenna device;

FIG. 6 is a return loss diagram for the antenna device according to the first variation;

FIG. 7 schematically shows a second embodiment of the antenna device according to the first variation together with a ground plane and a radio communication circuit;

FIG. 8 schematically shows a third embodiment of the antenna device according to the first variation together with a ground plane and a radio communication circuit; and

FIG. 9 schematically shows a general antenna device according to a second variation of the invention together with a ground plane and a radio communication circuit.

### DETAILED DESCRIPTION

Example embodiments will now be described more fully with reference to the accompanying drawings.

Exemplary embodiments are disclosed of antenna devices and portable radio communication devices including such antenna devices, where the antenna device is operable to receive radio signals in a first and a second operating frequency band. In an exemplary embodiment, there is an internal antenna device for use in a portable radio communication device, which provides a loop antenna having good wideband properties.

Aspects of the present disclosure are based on the realization that a desired wide band can be covered by a loop antenna element through merely connecting a capacitance to the ground end of the loop antenna element. With a good choice of the connection point on the loop antenna element and the capacitance, it is possible to make the loop antenna element function as a monopole element in a frequency range inside the desired band and thereby obtain a further resonance in order to cover the desired band.

In an exemplary embodiment, there is provided an antenna device for operating in at least one desired operational frequency band. The antenna device includes a loop element having a feeding end for connection to a radio communication circuit and a grounding end for connection to ground. The length of the loop element between the feeding and grounding ends is selected to provide loop resonance at a first wavelength. One resonance frequency associated with this first wavelength is a base resonance frequency for providing coverage of the desired frequency band. A first capacitance is provided between a first position on the loop element and ground, thereby dividing the loop element into a first section stretching between the feeding end and the first position and a second section stretching between the first position and the grounding end. The second section has an inductance depending on the length. The inductance forms a resonance circuit together with the first capacitance. The resonance circuit has a resonance frequency causing the loop element to function as a monopole element in a frequency range. The first position and the first capacitance are selected for the frequency range to lie in the desired frequency band. The first position is selected for giving the first section a length providing the loop element with a monopole resonance at a second wavelength. The second wavelength is selected so that one resonance frequency associated with this second wavelength lies within the frequency range in order to provide a first assisting resonance frequency, which assist in the coverage of the desired frequency band.

Exemplary embodiments are also disclosed of portable radio communication devices. In an exemplary embodiment, a portable radio communication device includes in its interior such an antenna device, a ground plane and a radio communication circuit connected to the antenna device.

As disclosed herein for exemplary embodiments, the antenna device provides operation with good performance throughout a wide frequency band. This is furthermore done with a minimum of or reduced number of components and elements, making the antenna device economical and easy to produce. The size can furthermore also be small.

The term “base resonance frequency” may be used herein to refer to or mean a resonance frequency which is used as a basic building block when providing coverage of a desired frequency band. The term “assisting resonance frequency” may be used herein to refer to or mean a resonance frequency used as a further building block that is added to a base resonance frequency for providing coverage of the desired frequency band.

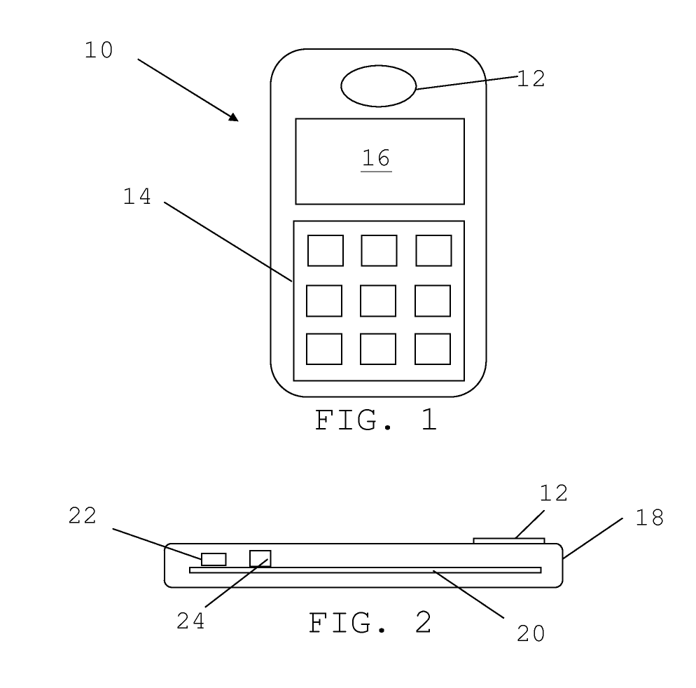

With reference to the figures. FIG. 1 is a front view of a portable radio communication device 10, such as a mobile phone. The portable radio communication device 10 can be another type of device, such as a laptop computer, a palm top computer, or an electronic organizer such as a personal digital assistant (PDA).

The device 10 is, as an example, provided with a speaker 12 placed close to an upper end of the device. A keypad 14 is placed close to a lower end of the device 10. A display 16 is in-between the speaker 12 and the keypad 14. These are here provided on the casing of the device 10. The device 10 may just as well be provided without a display, speaker, and/or keypad. The device 10 is also provided with at least one antenna. All antennas may be provided inside or in the interior of the device 10.

FIG. 2 shows a schematic side view of the device 10, which is a cross section through the casing 18. The speaker 12 is shown on the casing. In order to clarify the description only elements that are relevant or necessary for understanding are included. Thus, detailed description of a number of units in the device 10 have here been omitted, like for instance the keypad 14 and display 16 shown in FIG. 1.

The device 10 here includes a circuit board 20 on which an antenna device 22 is mounted according to this exemplary embodiment. On the board 20, there is furthermore a radio communication circuit 24, here the a cellular radio communication circuit, which may for instance be used to communicate in at least two separate frequency bands. The circuit board 20, which may be a multi-layer PCB (printed circuit board), furthermore includes a ground plane (not shown), which is used together with the antenna device 22.

As shown in FIG. 2, the antenna device 22 is placed on the circuit board 20. But other embodiments may include elements, like a radiating and/or radiation receiving element that extends beyond the circuit board or is even provided outside of this circuit board. It may for instance be folded around an edge of the circuit board or be placed outside of the board.

The antenna device 22 is placed far, e.g., as far as possible, from the speaker 12. The reason for this is that then interference caused by the antenna device 22 on a hearing aid is minimal, which helps in fulfilling HAC requirements being placed on the portable radio communication device.

According to a first variation, the antenna device comprises a loop element together with two capacitances. According to a second variation, the antenna device comprises a loop element together with only one capacitance, a capacitance near a grounding end of the loop element. A number of exemplary embodiments will now be disclosed based on the first variation.

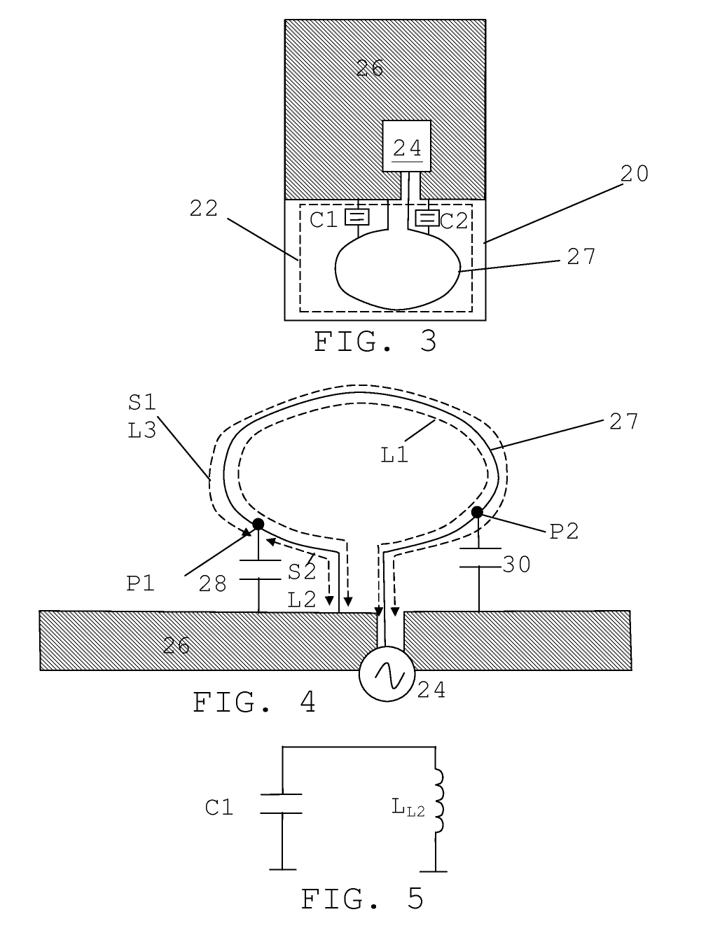

FIG. 3 schematically shows a general antenna device according to the first variation together with a ground plane 26 on the circuit board 20. On the board 20, there is furthermore provided the radio communication circuit 24 as well as a radiating and/or radiation receiving element 27. This radiating element 27 here has a first end, a feeding end, connected to the radio communication circuit 24 using the feeding conductor. The radiating element 27 also includes a second end, a grounding end, connected to the ground plane 26. On the circuit board 20, the radio communication circuit 24 is placed above the ground plane 26. The feeding conductor is not in contact with this ground plane, which in FIG. 3 is shown as a channel provided on the board 20 through the ground plane 26 where the connection is provided. Normally, this connection can be provided through the use of a coaxial cable or a microstrip line. The ground plane 26 will normally not include such a channel. The ground plane 26 and connection is only shown in this way in order to clearly show that the feeding end is not connected to ground.

In this example, the radiating and/or radiation receiving element 27 is a loop element. The antenna device 22 according to the first variation includes this loop element 27 together with a first C1 and a second capacitance C2 both provided between the loop element 27 and ground 26. The loop element 27 thus has a first end, a feeding end, connected to the radio communication circuit 24 and then runs in a loop to a grounding end, which is connected to the ground plane 26. This loop is here disclosed as elliptical. But the loop may have any suitable shape as long as the feeding end is connected to the radio communication circuit 24 and the grounding end is grounded. The feeding end is furthermore only connected to the radio communication circuit for receiving radio signals. There is no grounding at this end as for a Planar Inverted F Antenna (PIFA) element.

The capacitances C1 and C2 can be provided in different ways, and therefore are illustrated in FIG. 3 as boxes including the symbol of a capacitor. The first capacitance C1 is here provided between the loop element 27 and ground 26 close to the ground end. The second capacitance C2 is provided between the loop element and ground 26 close to the feed end.

FIG. 4 schematically shows the antenna device according to a first embodiment. Here, the loop element 27 has the same shape as shown in FIG. 3. The radio communication circuit 24 is shown as an AC voltage source. The first and second capacitances C1 and C2 are provided as discrete capacitor components, and are therefore illustrates as ordinary capacitor symbols. There is here a first component 28 providing the first capacitance C1 and a second component 30 providing the second capacitance C2.

FIG. 4 furthermore shows that the loop element 27 has a length L1 from the feeding to the grounding end. FIG. 4 also shows that the first capacitor 28 is connected between a first position P1 on the loop element 27 and ground. This means that the first capacitance C1 is provided between the position P1 on the loop element and ground. Through this first position P1, the loop element is furthermore divided into two sections a first section S1 and a second section S2. The first section S1 stretches between the feeding end and the first position P1. The second section S2 stretches between the first position P1 and the grounding end. The first section furthermore has a length L3, while the second section has a length L2.

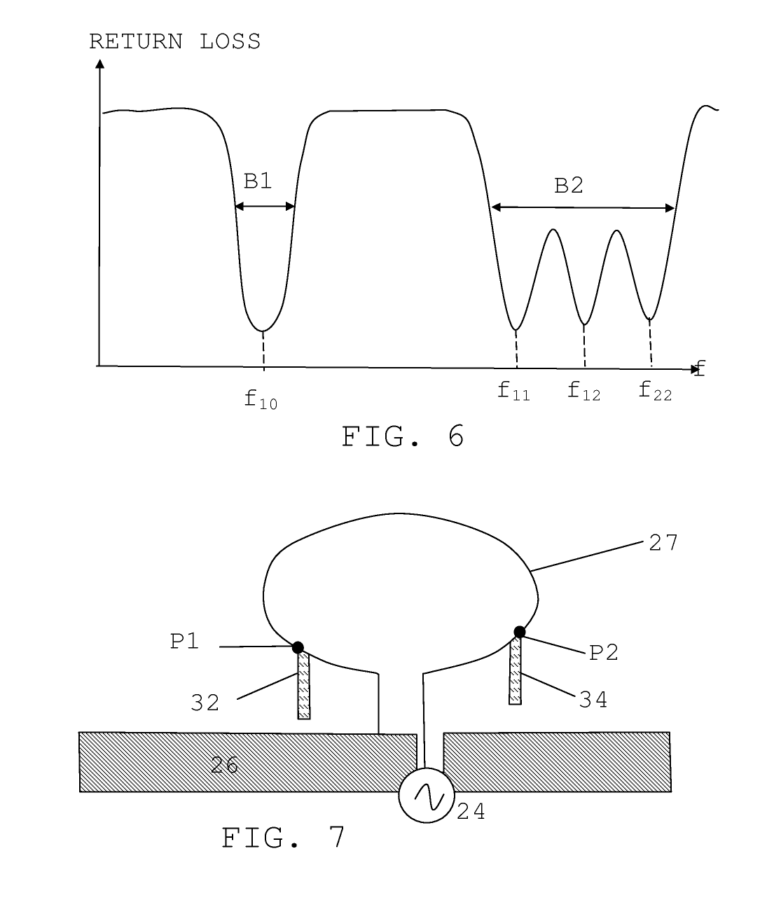

The functioning of the antenna device according to the first variation will now be described with reference also being made to FIGS. 5 and 6. FIG. 5 shows a resonance circuit formed by the antenna device. FIG. 6 shows a return loss diagram for the antenna device according to the first variation.

The length L1 of the loop element 27, which is also the circumference of the loop, is here selected to provide loop resonance at a first fundamental frequency f₁₀ in a first frequency band B1 and at a first harmonics frequency f₁₁ in a second frequency band B2. The first frequency band may be the 900 MHz frequency band, while the second frequency band may be the 1710-2170 MHz band. The first band is a lower band of medium width, while the second band B2 a higher band of higher width. The loop element also has a second harmonics frequency f₁₂. The second harmonics frequency is the second order harmonics frequency. This latter frequency is furthermore provided outside and also above the second frequency band. It may for instance lie at about 2400 MHz

For a first wavelength λ₁ at which this loop resonance occurs, the first fundamental frequency f₁₀ is at λ₁/2, the first order harmonics frequency f₁₁ is at λ₁ and the second order harmonics frequency f₁₂ is at 3λ₁/2. These frequencies apply when the loop element operates in a loop antenna mode. L1 is then selected to be λ₁/2. All these frequencies are thus frequencies associated with this first wavelength. From this, it can be understood that the length L1 of the loop element is selected to provide loop resonance at this first wavelength. One of these resonance frequencies is furthermore selected to be a base resonance frequency. A base resonance frequency is a frequency, which is to be used as a basic building block in order to cover a desired frequency band. One or more assisting resonance frequencies are added to this base resonance frequency, for providing the frequency band coverage. In the example given here, the second frequency band B2 is this desired frequency band, and the first order harmonics of the first wavelength is the base resonance frequency. In the first variation, there are two assisting resonance frequencies. But in the second variation, there is only one assisting resonance frequency. In this first variation, the second order harmonics associated with the first wavelength is used for providing one such assisting resonance frequency.

The fundamental frequency described above provides sufficient coverage of the first band B1. But the first order harmonics frequency is not able to cover the second band B2 by itself. Something has to be done.

Through placing the first capacitance C1 at the first position P1, the loop element is divided into the first and the second sections S1 and S2, where the second section has a length L2 and the first section S1 has a length L3. The loop element 27 is thus divided into a first section S1 stretching between the feeding end and the first position P1 and a second section S2 stretching between the first position P1 and the grounding end. The second section S2 has an inductance L_{L2} that is dependent on the length L2. This furthermore means that as the first capacitance C1 and the grounding end of the loop are connected to ground there is created a resonance circuit made up of the first capacitance C1 and the inductance L_{L2} of the second section S2 of the loop element 27.

This resonance circuit has a resonance frequency f_{rc} determined through (2π*SQR(L_{L1}C₁))⁻¹.

The resonance circuit therefore provides resonance in a frequency range covering the resonance frequency f_{rc}. In this range, the functioning of the loop element 27 is changed. This means that in this range the loop element 27 no longer acts as if the second end is grounded. Instead, the loop element 27 is acting as an open-ended monopole element. It here operates in a monopole mode where it may act as a long monopole element. More particularly, it is in fact the first section S1 of the element 27 that acts as a monopole element.

The first position P1 and the first capacitance C1 are selected for the resonance frequency f_{rc} of the resonance circuit to lie in said desired frequency band, to here lie in the second frequency band B2.

The length L3 of this first section is then selected for providing a further resonance. The first position P1 is thus selected for giving the first section S1 a length L3 for providing the loop element with a monopole resonance at a further frequency. Here, this further frequency is in the second frequency band B2.

For a second wavelength λ₂ associated with this monopole resonance, the first fundamental frequency f₂₀ is provided at λ₂/4, the first order harmonics frequency f₂₁ provided at λ₂/2 and the second order harmonics frequency f₂₂ at 3λ₂/4. The length L3 is in this second embodiment selected to correspond to λ₂/4. If then one of these frequencies f₂₀, f₂₁ or f₂₂ lies in the frequency range of the resonance circuit, the loop element will have a further resonance, a monopole resonance, at this frequency. In this embodiment, the frequency that is selected to lie within the frequency range is the second order harmonics frequency f₂₂.

It can thereby be seen that the first position P1 is selected for giving the first section S1 a length L3 providing the loop element with a monopole resonance at a second wavelength λ₂, which second wavelength λ₂ is selected so that one resonance frequency, here the second harmonics frequency f₂₂, associated with this second wavelength lies within the frequency range of the resonance circuit. In this way, a first assisting resonance frequency is provided, which first assisting frequency in this example is the second harmonics frequency f₂₂. This first assisting resonance frequency thereby assists the base resonance frequency f₁₁ in the coverage of the desired frequency band. Put slightly differently, the position of the first point P1 on the loop element 27 and thereby also the length L3 is selected for the second order monopole harmonics resonance frequency f₂₂ of the first section S1 to lie in the frequency range where the resonance circuit resonates. In this embodiment, this first assisting resonance frequency f₂₂ is furthermore set to be equal to the resonance frequency f_{rc} of the resonance circuit.

This first assisting frequency is here furthermore selected so that it lies in the second band B2 adjacent a loop resonance frequency. This is a resonance frequency associated with the first wavelength and thus the coverage of the second band B2 is improved. The length of the first section is thus chosen for providing the first assisting resonance frequency close to a loop resonance frequency associated with the first wavelength in the desired frequency band. In this way, improved wideband coverage in the second band B2 is obtained.

According to the first embodiment, this coverage is improved even further through the use of the second capacitance C2. As mentioned above, the second order harmonics frequency f₁₂ of the basic loop element lies outside of the second band B2. According to the first variation, this frequency is shifted through the use of the second capacitor C2 such that it will appear in the second band B2. This means that in the present example, the second capacitance C2 is selected to have a value that causes the second order harmonics frequency to be shifted into to the second band B2.

The value of the second capacitance C2 is thus selected to provide a shift of the second order harmonics frequency f₁₂ into the second frequency band. In this way, this frequency is made into a second assisting resonance frequency assisting in the coverage of the desired frequency band.

The second capacitance is here furthermore selected so that the second assisting resonance frequency is shifted to lie adjacent at least one other resonance frequency contributing to the coverage of the desired frequency band, in this example adjacent either the base resonance frequency or the first assisting resonance frequency.

In the first variation, it is shifted to lie adjacent both, through being shifted to lie in-between the first harmonics frequency of the loop resonance and the first harmonics frequency of the monopole resonance. Thus, in this example, the first position P1 and first and second capacitances C1 and C2 are selected such that the second assisting resonance frequency is placed between the base resonance frequency and the first assisting resonance frequency. This can be seen in FIG. 6.

In this way, it is possible to provide a very wide second band with a limited number of components. This also means that the antenna device is easy to produce and the production costs are low. The antenna device can also be kept small.

It is possible to vary which resonance is to lie beside which. It is for instance possible that the first assisting resonance frequency is provided in the middle of the band as well as to provide the base resonance frequency in the middle. It is furthermore possible to select other frequencies associated with the first and second wavelengths to be used as assisting resonance frequencies, for instance harmonics resonance frequencies of other orders. The base resonance frequency may therefore also be another harmonics frequency than of the first order. It may also be a fundamental frequency as may the first assisting resonance frequency. From this, it can be understood that the present invention does not require the coverage of the above-mentioned first frequency band. There may therefore be only be one band covered. The invention is furthermore not limited to the two specific bands described above, but can be applied on any frequency bands.

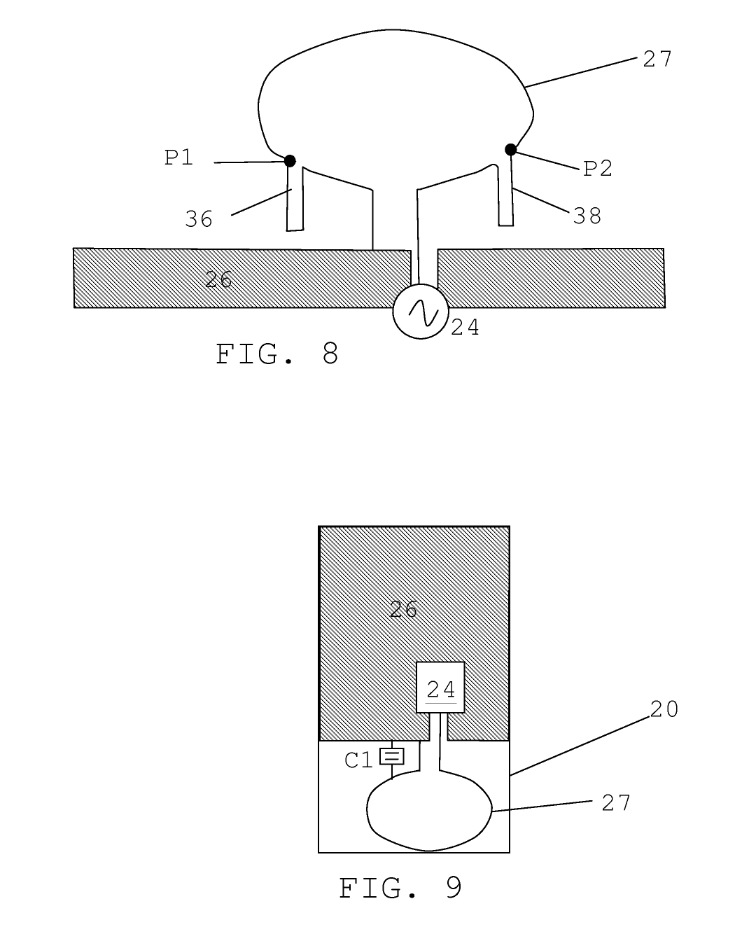

As mentioned above, the first and second capacitances can be provided in different ways. In a second embodiment shown in FIG. 7, the first and second capacitances are provided as plates 32 and 34 attached to the loop element 27 at the positions P1 and P2. The plates 32 and 34 stretch towards the ground plane 26. The capacitances C1 and C2 are then determined through the widths of these plates and the distance between the plates and the ground plane.

According to a third embodiment, the first and second capacitances can also be provided through a bending of the loop structure as can be seen in FIG. 8. A part 36, 38 of the loop element 27 at each end is thus placed at a distance from a ground plane 26, where the width of the part and the distance to the ground plane 36 determines the capacitance.

In the drawings, the first and the second capacitances are shown as provided symmetrically on two sides of the middle of the loop element. It should be realized that this is in no way any requirement. The realization of a first capacitance according to any of the above mentioned embodiments can be combined with the realization of the second capacitance according to any of the other embodiments.

According to a second variation, the present invention can be realized without shifting the second harmonics frequency of the loop resonance. Then, of course, the second capacitance is omitted. This is schematically shown in FIG. 9, which in all other respects is similar to FIG. 3.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms (e.g., different materials, etc.), and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values (e.g., frequency ranges or bandwidths, etc.) for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed:

1. An antenna device for operation in at least one desired operational frequency band, the antenna device comprising:
a loop element having a feeding end for connection to a radio communication circuit and a grounding end for connection to ground, wherein the length of the loop element between the feeding and grounding ends provides loop resonance at a first wavelength, where one resonance frequency associated with this first wavelength is a base resonance frequency for providing coverage of the desired frequency band;
a first capacitance between a first position on the loop element and ground, thereby dividing the loop element into a first section between the feeding end and the first position and a second section between the first position and the grounding end;
wherein the second section has an inductance depending on a length of the second section, the inductance forming a resonance circuit together with the first capacitance, which resonance circuit has a resonance frequency causing the loop element to function as a monopole element in a frequency range; and
wherein the first position and the first capacitance are configured for the frequency range to lie in the desired frequency band, and the first position is configured such that the first section has a length for providing the loop element with a monopole resonance at a second wavelength, such that one resonance frequency associated with this second wavelength lies within the frequency range in order to provide a first assisting resonance frequency, which assist in the coverage of the desired frequency band.

2. The antenna device of claim 1, wherein the resonance frequency of the resonance circuit and the first assisting resonance frequency are the same.

3. The antenna device of claim 1, wherein the length of the first section provides the first assisting resonance frequency close to a loop resonance frequency associated with the first wavelength in the desired frequency band.

4. The antenna device of claim 1, wherein the first assisting resonance frequency is a harmonics frequency associated with the second wavelength.

5. The antenna device of claim 1, wherein the base resonance frequency is a harmonics frequency associated with the first wavelength.

6. The antenna device of claim 1, wherein:
a second assisting resonance frequency associated with the first wavelength lies outside the desired frequency band; and
the antenna device further comprises a second capacitance at a second position of the loop element between the feeding end and the first position, and operable to to shift the second assisting resonance frequency into the desired frequency band for assisting in the coverage.

7. The antenna device of claim 6, wherein the second capacitance is operable to shift the second assisting resonance frequency to lie adjacent at least one other resonance frequency contributing to the coverage of the desired frequency band.

8. The antenna device of claim 7, wherein the first position and the first and second capacitances are configured such that the second assisting resonance frequency is placed between the base resonance frequency and the first assisting resonance frequency.

9. The antenna device of claim 1, wherein at least one capacitance is realized through a capacitor component.

10. The antenna device of claim 1, wherein at least one capacitance is realized through placing a part of the loop element at a distance from a ground plane causing the capacitance to occur.

11. The antenna device of claim 10, wherein the capacitance is determined through the width of the part and the distance to ground.

12. The antenna device of claim 1, wherein at least one capacitance is provided through a plate being attached to the loop element and stretching towards the ground plane.

13. The antenna device according to claim 12, wherein the capacitance is determined through the width of the plate and its distance to ground.

14. The antenna device according to claim 1, wherein:
the loop element is operable in a first and a second frequency band;
the desired frequency band is the second frequency band;
the length of the loop element between the feeding and grounding ends is provides loop resonance at a fundamental frequency associated with the first wavelength in the first frequency band and at a first harmonics frequency in the second frequency band; and
the base resonance frequency is the first harmonics frequency.

15. A portable radio communication device comprising in its interior:
an antenna device of claim 1;
a ground plane; and
a radio communication circuit connected to the antenna device.
